(19) United States
(12) Patent Application Publication
(10) Pub. No.: US 2019/0035551 A1
(43) Pub. Date: Jan. 31, 2019

(54) WIRE-SELECTING DEVICE

(71) Applicants: U. D. ELECTRONIC CORP., Taoyuan City (TW); U. D(DONGGUAN). ELECTRONIC TECHNOLOGY CORP., Dongguan City (CN)

(72) Inventors: LIANG-YU CHOU, Taoyuan City (TW); CHIH-FENG CHIEN, Taoyuan City (TW)

(21) Appl. No.: 15/661,050

(22) Filed: Jul. 27, 2017

(51) Int. Cl. H01F 41/06; G06K 9/00; G06K 9/20

(52) U.S. Cl. CPC H01F 41/06; G06K 2209/19; G06K 9/209; G06K 9/00624

(57) ABSTRACT

The present invention discloses a wire-selecting device, which comprising a visual discriminating system, a wire-selecting module, and a core positioning seat to be processed. The visual discriminating system comprises an image capturing module and a discriminating module, and judges the appearance of the wire obtained by the module according to the image capturing module And the wire-selecting module includes a plurality of wire-selecting clamps for holding the wires, the sub-clamp group receives the wire-selecting control information from the visual discrimination system; the processing core positioning seat includes A plurality of wire-selecting positioning blocks for holding a plurality of wires, wherein the sub-threading clamps hold a plurality of sub-wire clips correspondingly according to the wire-selecting control information, and after the completion of the wire-selecting operation, The wire is moved to the to-be-processed core positioning seat for subsequent processing.

### BACKGROUND OF THE INVENTION

### 1. Field of the Invention

The present invention relates to the technology field of automatic mechanical device, and more particularly to a wire-selecting device.

### 2. Description of the Prior Art

Nowadays, cloud technology and network applications is becoming the most popular, such as a personal computers, workstations, servers and other electronic devices have become increasingly large, these devices need to go through such as RJ45 or a variety of network ports for transmission, and in the network port Interface, often with Pulse transformer and/or Common-mode filter of the magnetic components to achieve DC isolation, noise suppression and maintain high-speed digital signal transmission quality.

Please refer to FIG. 1. where a cross-sectional view of a magnetic component is shown. As FIG. 1 shows, the magnetic component comprises: a seat body A′, a connection terminal B1′, an iron core C′, and an upper cover D′. In the production of the magnetic element, the iron core C′ has to be wound around the wires C1′ of different colors by manual or automatic winding, and the corresponding color wires C1 are electrically connected according to the electrical requirements of the magnetic elements (DC insulation or noise suppression) Is wound onto the corresponding connecting terminal B1′ on a winding bar B2′ and then welded to connect, so that the wires C1′ can be connected to the correct contact to allow the magnetic element to operate properly.

However, whether through the manual or automatic winding, after the end of the line after the end of the wires C1′ is a messy tangled, so consumers in the design of their own circuit to meet the needs of the use of magnetic components, the previous wire-selecting are only can rely on the human eye to determine and select the corresponding wire C1′ color after the subsequent winding to the wire or welding process. However, the manual wire-selecting time and labor, but also cause slow production, high rate of bad, and process costs increase and loss.

Accordingly, inventors of the present application have made great efforts to make inventive research thereon and eventually provided a wire-selecting device.

### SUMMARY OF THE INVENTION

The primary objective of the present invention is to provide a wire-selecting device for a magnetic element comprises an iron core for winding a plurality of metal lines and at least two of the metal lines having a different metal lines appearance.

Accordingly, in order to achieve the primary objective of the present invention, the inventor of the present invention provides an embodiment for the wire-selecting device, comprising:
a visual recognition system, comprising:
   an image capture module, providing an image acquisition is determined by a plurality of metal wires to obtain a wire appearance information; and
   a discrimination module, being connected to the image capture module; wherein the discrimination module providing a wire-selecting control information is determined by the image acquisition;
a wire-selecting module, comprising:
   a plurality of sub-clamps, being connected to the visual recognition system; wherein the sub-clamps are used to holding the metal wires at a wire-selecting position;
a pending iron core seat, comprising:
   a base;
   a first sub-positioning seat, being disposed in the base and having a plurality of thread holding portions; wherein the thread holding portions provided at one end and the opposite end of the seat in a first direction so as to position the iron core in a waiting position;
   wherein the wire-selecting module is respectively to perform a wire-selecting action so that the sub-clamps clamp the metal wires correspondingly to the metal wires and the metal wires from the wire-selecting position, which is displaced to the pending iron core seat, therefore the iron core is fixed to the to-be-treated position for subsequent processing.

In the embodiment of the wire-selecting device, the plurality of sub-clamps further comprises: a body, a plurality of ramming shaft body and a plurality of clamping arms, which are arranged on the body and arranged in parallel and each of which is provided on the body and correspondingly disposed above the holding arm, the wire-selecting module receives the wire-selecting control information from the visual discriminating system so that the ramming shaft body is pressed up and down to hold or open the clamping arm.

In the embodiment of the wire-selecting device, the plurality of clamping arms further comprises: an L-shaped holding member, an elastic member, and an abutment block which is fixed to the body and has a recess formed on the top surface which is displaceable provided on the top surface and a tail portion extending upwardly along the rear end to form a margin space which is provided in the groove along the direction of the abutting direction of the holding member and which is located in the abutment block Between the holding pieces.

In the embodiment of the wire-selecting device, further comprises: a core fixing mechanism having a magnetic member and a core clip, the core fixing mechanism being disposed in the visual recognition system, and the iron core clamping mechanism is provided on both sides of the magnetic member, and the iron core fixing mechanism fixes the iron core at the distance.

In the embodiment of the wire-selecting device, the core fixing mechanism further comprises: Two wire clips, which are displaceable provided in the wire-selecting device, the wire clips being arranged on both sides of the core and holding the plurality of metal wires, and the two wire clips are held by the plurality of wires, respectively, in a direction away from the core to pull the plurality of metal wires to a predetermined tension strength.

In the embodiment of the wire-selecting device, the wire-selecting module further comprises: a wires baffle device having a plurality of guide grooves, which used for limiting the plurality of metal wires between the respective guide grooves.

In the embodiment of the wire-selecting device, the pending iron core seat further comprises: an iron core clip, being disposed on the base, wherein the core fixing clip having two gripping arms, the clamping surfaces of the gripping arms are substantially matched to the outer shape of the core and the distance between the lower edges of the gripping faces of the gripping arms is smaller than that of the core thickness.

In the embodiment of the wire-selecting device, the pending iron core seat further comprises: a second sub-positioning seat, being disposed in the base and having a plurality of thread holding portions; wherein the plurality of the second wire-selecting positioning seats is respectively provided at one end and the opposite end of the seat in a second direction, and the second direction is substantially perpendicular to the first direction.

In the embodiment of the wire-selecting device, the image capturing module is arranged below the number of the sub-clamps corresponding to the number of the sub-clamps so that the image capturing direction of the image capturing module is substantially toward the plurality of metal wires, thereby performing the image acquisition operation on the plurality of metal wires.

In the embodiment of the wire-selecting device, the visual discriminating system further comprises: a light emitting element which is enclosed in the image capturing module and the light emitting direction of the light emitting element is substantially oriented toward the plurality of metal wires.

Accordingly, to achieve the primary objective of the present invention, the inventor of the present invention provides the shape of the metal wires of the plurality of metal wires wound around the core is identified by the visual discriminating system and can be resolved, clamped and moved to the core to be treated for subsequent processing. Process automation, improve the production process of magnetic components and reduce the rate of non-performing.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 is a cross-sectional of a magnetic component;

FIG. 2 is a stereo view of a magnetic component;

FIG. 3 is a conceptual diagram of a wire-selecting device according to the first embodiment of the invention;

FIG. 4 is a top plan view of a wire-selecting device according to the first embodiment of the invention;

FIG. 5 is a stereo view of a pending iron core seat according to the first embodiment of the invention;

FIG. 6 is a stereo view of a sub-clamps according to the first embodiment of the invention;

FIG. 7A-FIG. 7I are a schematic view of a wire-selecting device for wire-selecting action according to the first embodiment of the invention;

FIG. 8 is a conceptual diagram of a wire-selecting device according to the second embodiment of the invention;

FIG. 9 is a top plan view of a wire-selecting device according to the second embodiment of the invention;

FIG. 10 is a stereo view of a pending iron core seat according to the second embodiment of the invention;

FIG. 11 is a conceptual diagram of a wires baffle device according to the second embodiment of the invention;

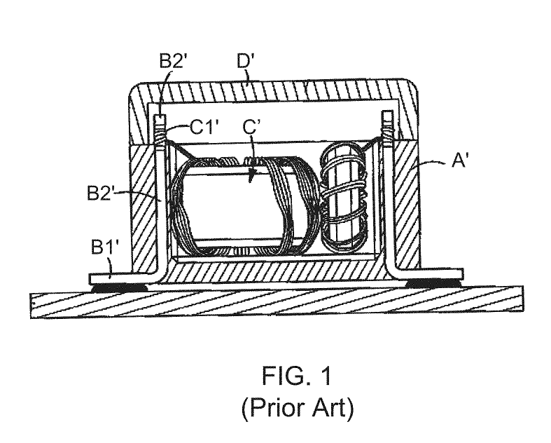

### DETAILED DESCRIPTION OF THE PREFERRED EMBODIMENTS

To more clearly describe a bicycle safety lamp according to the present invention, embodiments of the present invention will be described in detail with reference to the attached drawings hereinafter.

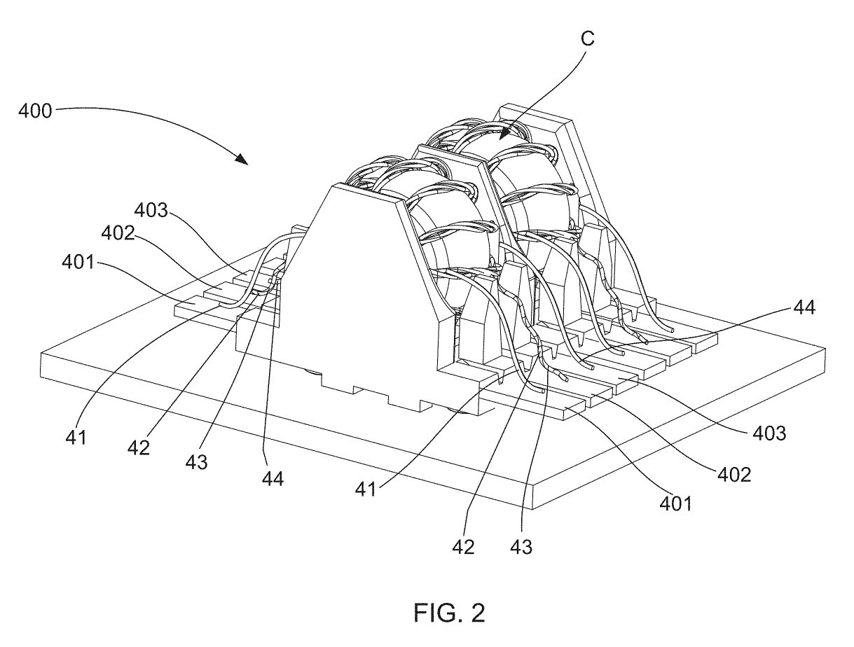

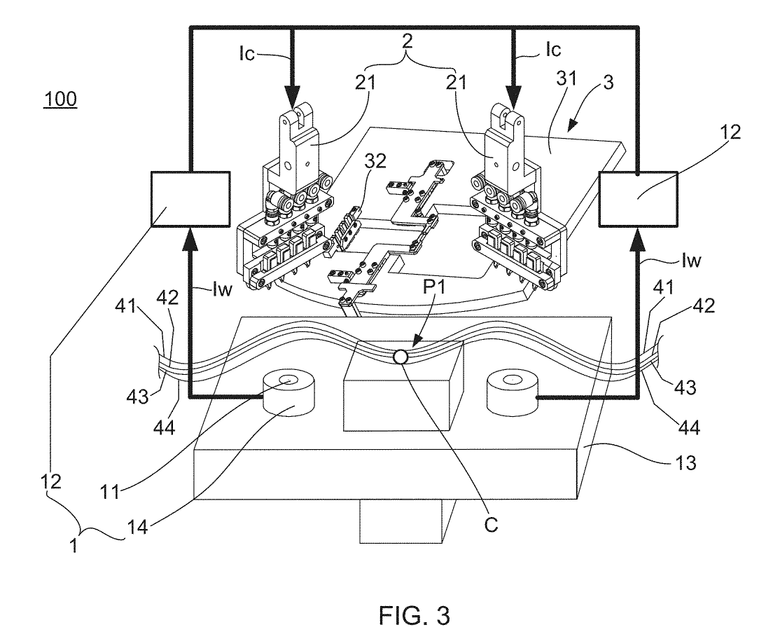

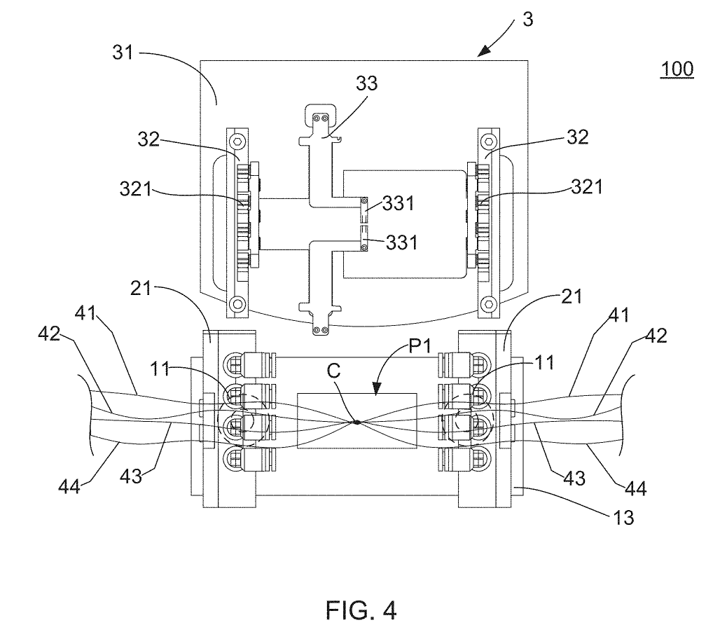

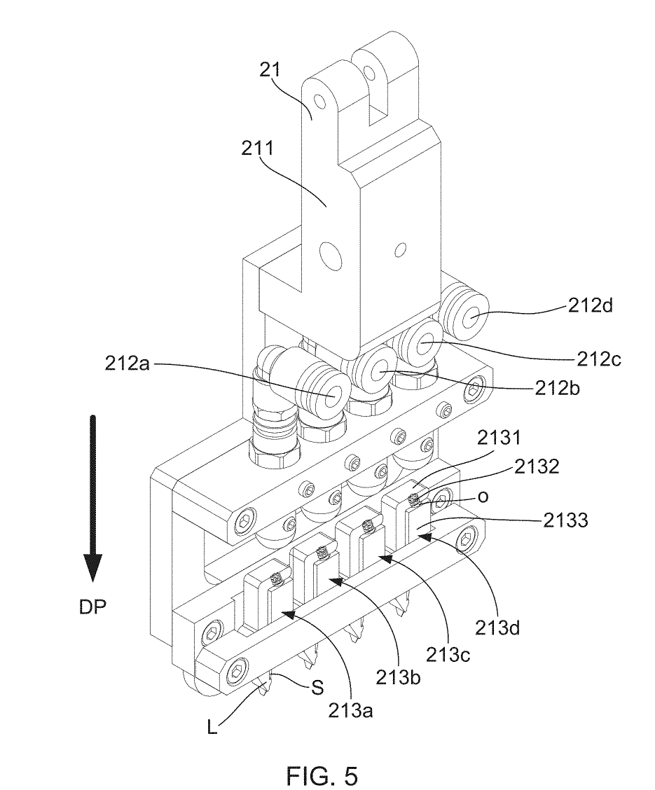

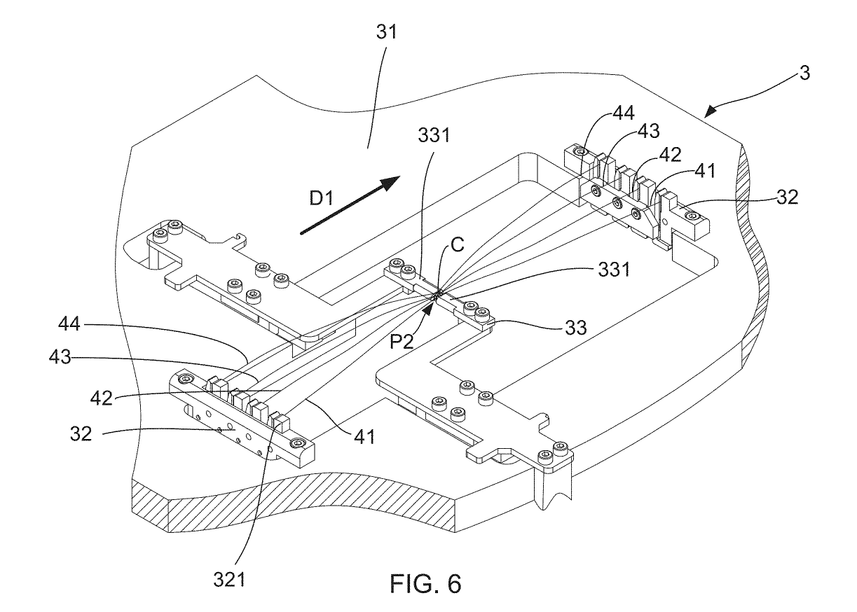

Please simultaneously refer to FIG. 2, FIG. 3, FIG. 4, FIG. 5, and FIG. 6, where a stereo view of a magnetic component, a conceptual diagram of a wire-selecting device according to the first embodiment of the invention, a top plan view of a wire-selecting device according to the first embodiment of the invention, a stereo view of a pending iron core seat according to the first embodiment of the invention, and a stereo view of a sub-clamps according to the first embodiment of the invention are shown, respectively. As the diagrams shown in FIG. 2-FIG. 6, the wire-selecting device 100 for a magnetic element 400 and an icon core C wind a plurality of metal wires 41-44 wound therein of the first embodiment of the invention mainly comprises: a visual recognition system 1, a wire-selecting module 2, and a pending iron core seat 3. In which, the visual recognition system 1 comprises an image capture module 11, and a discrimination module 12 is connected to the image capture module 11. In the present invention, the image capture module 11 providing an image acquisition is determined of a plurality of metal wires 41-44 to obtain a wire appearance information Iw.

Inheriting to above descriptions, the discrimination module 12 providing a wire-selecting control information Ic is determined by the image acquisition Iw. Moreover, the wire-selecting module 2 comprises a plurality of sub-clamps 21 and connected to the visual recognition system 1 for received wire-selecting control information Ic, wherein the sub-clamps 21 are used to holding the metal wires 41-44 at a wire-selecting position P1. In which, the pending iron core seat 3 comprises a base 31, and a first sub-positioning seat 32 is disposed on the base 31 and having a plurality of thread holding portions 321; wherein the thread holding portions 321 provided at one end and the opposite end of the base 31 in a first direction D1 so as to position the iron core C in a waiting position P2. In the present invention, the wire-selecting module 2 is respectively to perform a wire-selecting action so that the sub-clamps clamp 21 the metal wires 41-44 correspondingly to the metal wires 41-44 and the metal wires 41-44 from the wire-selecting position P1, which is displaced to the pending iron core seat 3, therefore the iron core C is fixed to the waiting position P2 for subsequent processing.

With reference to FIG. 2, there is provided a stereo view of a magnetic component. As FIG. 2 shows, the icon core C of the magnetic element 400 is annular and wound with four sets of metal wires 41-44, which are four colors of red, blue, green and yellow (i.e., different crystal appearances). In other embodiments, the icon core C may be of the square, T type, I type or other shape, and the wire wound on the icon core C is not limited to four groups, and not limited to the case of the icon core C.

Inheriting to above descriptions, the wire-selecting device 100 is a stand-alone machine or incorporated into one of the workstations of an automated production facility, depending on the operational requirements of the magnetic element 400 or in accordance with the appearance of the metal wire, Wire color and set). In the present embodiment, the image capturing module 11 is provided on a base 13 which is provided below the sub-clamps 21 corresponding to the number of sub-clamps 21, respectively, and therefore the image capturing module 11 is substantially oriented toward the plurality of metal wires 41-44, thereby performing image capturing of the plurality of metal wires 41-44 obtain the wire appearance information Iw.

Moreover, the image capturing module 11 is an optical image lens capable of taking an object to obtain the appearance information of the object. In the present embodiment, the image capturing module 11 is provided below the sub-clamps 21, but as long as the image capturing directions of the image capturing module 11 are substantially tangible to the plurality of metal wires 41-44 The image and image capturing module 11 may be provided on the left or right sides of the plurality of metal wires 41-44.

Furthermore, the wire appearance information Iw is the plurality of metal wires 41-44 positions, Wire color (red, blue, green, yellow, etc.), wire diameter (ie, line thickness), or linear (round, square, or semicircular).

In the present of invention, The discrimination module 12 is a CPU or a PLC controller and control the corresponding control to receive the wire appearance information Iw using the written programmable language and generate the wire-selecting control information Ic based on the wire appearance information Iw, and therefore the plurality of sub-clamps 21 perform a wire-selecting operation to hold the corresponding wires and then place them in a position for facilitating subsequent processing.

Please continuously refer to FIG. 5, the plurality of sub-clamps 21 comprises a body 211, a plurality of ramming shaft body 212a-212d and a plurality of clamping arms 213a-213d, which are arranged on the body and arranged in parallel and each of which is provided on the ramming shaft body 212a-212d and correspondingly disposed above the clamping arms 213a-213d, the wire-selecting module 2 receives the wire-selecting control information Ic from the visual discriminating system 1 so that the ramming shaft body 212a-212d is pressed up and down to hold or open the clamping arm 213a-213d.

In the present of invention, the sub-clamps 21 correspond to the terminals on both sides of the magnetic element 400 and each of the sub-clamps 21 has four sets of clamping arms 213a-213d to correspond to the number of the wires 41 to 44 The In other embodiments, the sub-clamps 21 may also be provided with hooks for gripping the wires, or by catching the wires in a snap-in manner, the clamping arms being merely exemplary applications, the present invention is not limited thereto.

Inheriting to above descriptions, the magnetic element 400 is set as a first end 401 connecting metal wires 41, and a second end 402 is connected to the twisted metal wire 42 and the metal wire 43 and a third terminal 403 connecting wire 44 to operate normally so that the wire-selecting device 100 The above-described demand for the normal operation of the magnetic element 400, thereby determining the gripping sequence and the position. As to how the wire-selecting device 100 performs a wire-selecting operation, it will be described later.

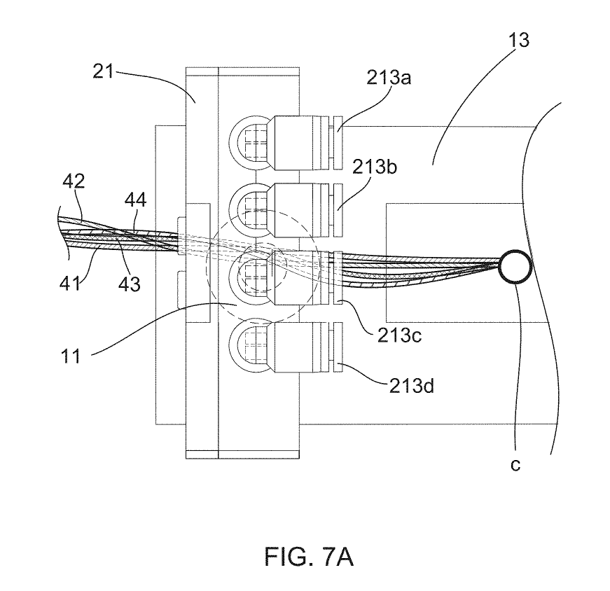

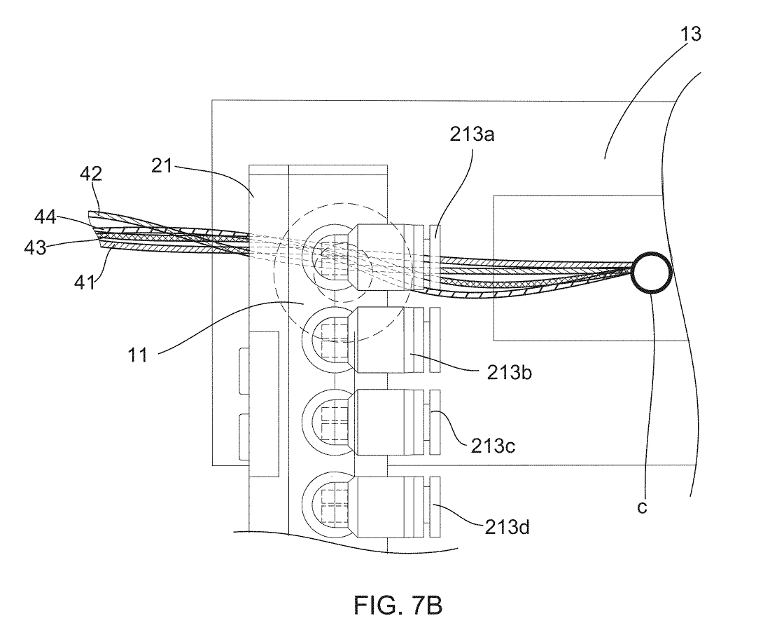

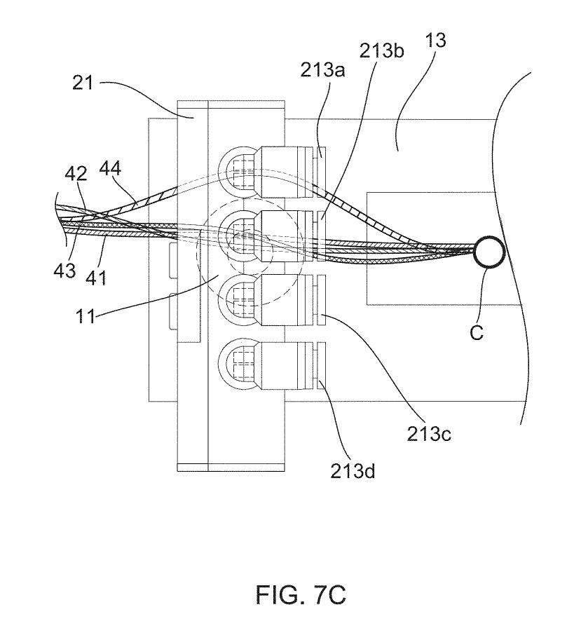

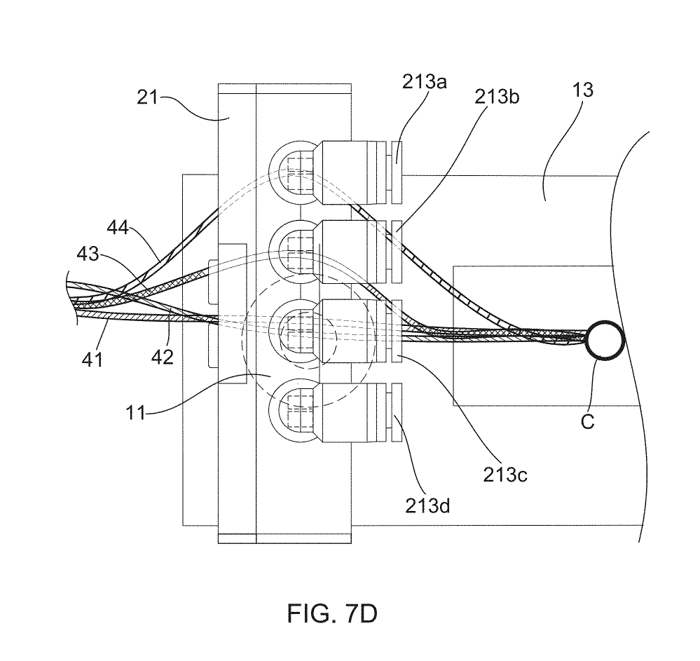

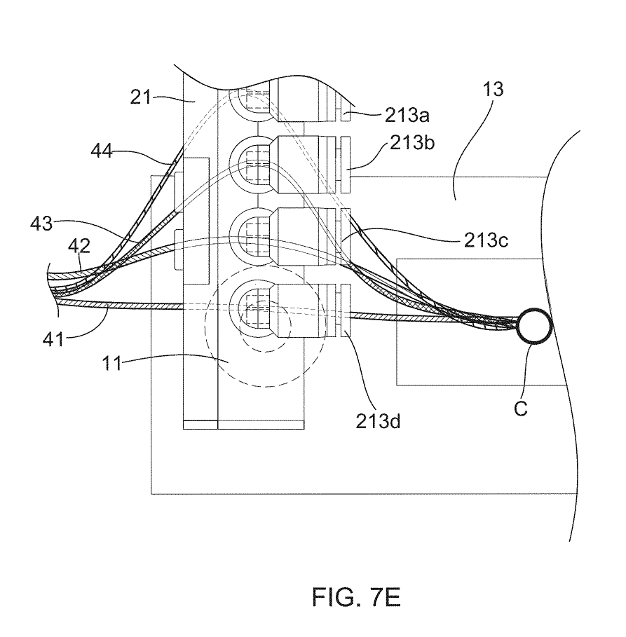

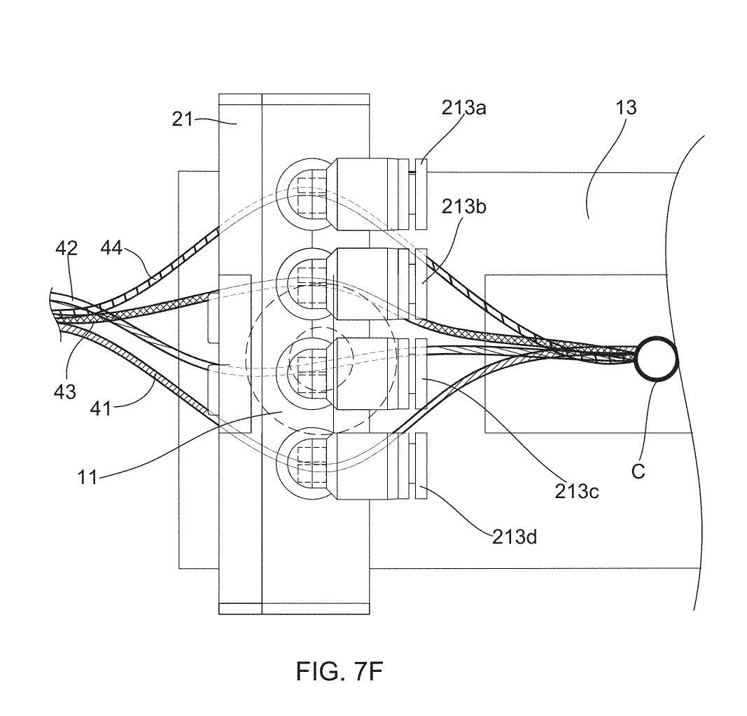

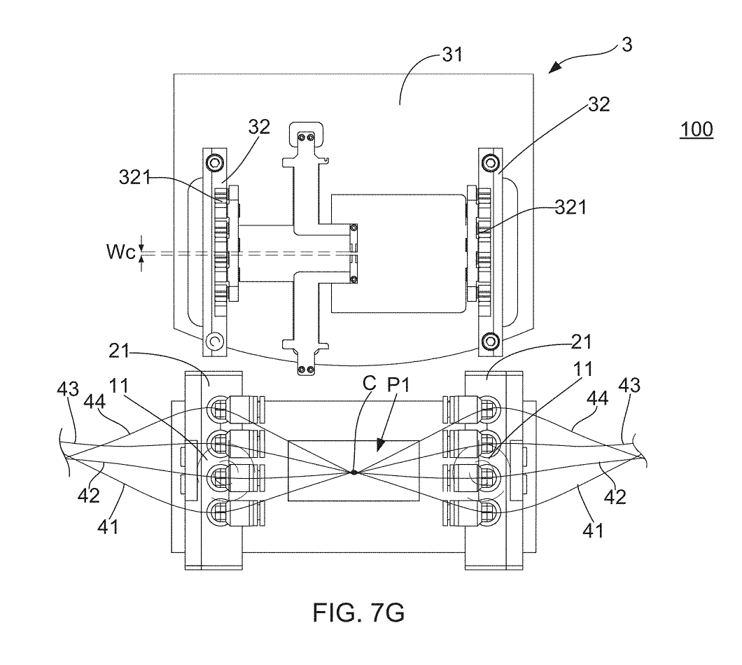

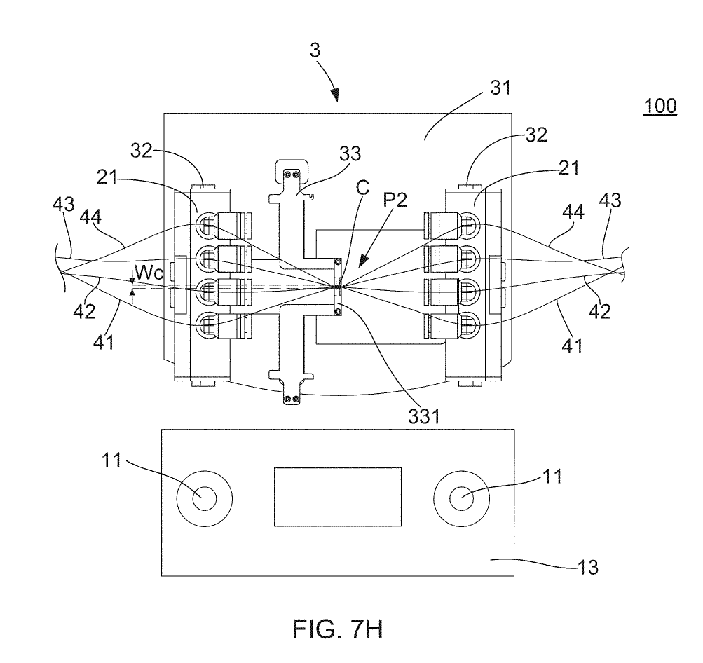

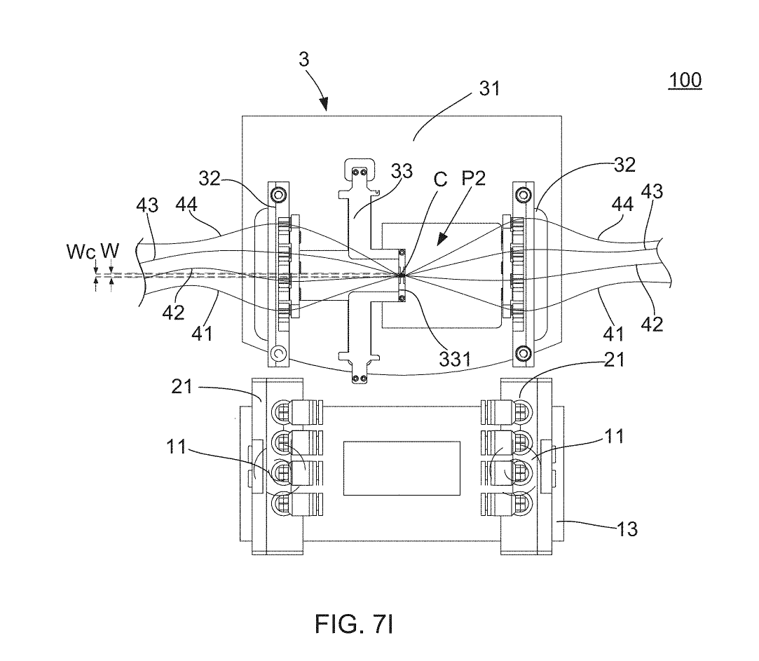

Please simultaneously refer to FIG. 7A-FIG. 7I, there are a schematic view of a wire-selecting device for wire-selecting action according to the first embodiment of the invention. As shown in FIG. 7A-FIG. 7I, First, when the icon core C and the metal wires 41-44 are at the wire-selecting position P1, the image capturing module 11 captures and discriminates the appearance of the metal wires 41-44 to generate the wire appearance information Iw. The wire appearance information Iw has included the position and color of each wire. Therefore, the discrimination module 12 receives the wire appearance information Iw, confirms the position of the metal wires 41-44, and the color thereof, and then generates the wire-selecting control information Ic to the wire-selecting module 2. Then, the wire-selecting control information Ic is transmitted to the wire-selecting module 2, and therefore the s wire-selecting module 2 can be controlled to grip a specific position and a specific appearance of the wire, and the wire-selecting module 2 then controls the sub-Above the metal wire 44, the clamp arm 213a is gripped and held against the metal wire 44, and then the wire-selecting module 2 moves the sub-clamps 21 to the upper side of the wire 43 so that the clamp arm 213b is aligned with the wire Hold and hold, and so on, one by one to hold and hold the wires 41-44, to complete the wire-selecting action. When the wire-selecting operation is completed, the wire-selecting module 2 displaces the icon core C and the metal wires 41-44 from the wire-selecting position P1 to the pending iron core seat 3, and the iron core C And the metal wires 41-44 are fixed to the waiting position P2 to be processed so as to perform subsequent stranding, spot welding, gluing, and cutting operations.

According to the technical means employed in the present invention, the plurality of metal wires 41-44 wound around the icon core C can be resolved, clamped, and fixed to the wires to be processed the pending iron core seat 3 is treated for subsequent processing so as to realize the automation of the wire-selecting process, to improve the production speed of the magnetic element process and to reduce the defective rate.

Referring to FIG. 3 and FIG. 4 again, the visual discriminating system 1 further comprising a light emitting element 14, which is enclosed in the image capturing module 11 and the light emitting 14 direction of the light emitting element is substantially oriented toward the plurality of metal wires 41-44, therefore the plurality of metal wires 41-44 can be easier for the recognized image capturing module 11.

Referring to FIG. 5 again, the plurality of clamping arms 213a-213d comprises: an L-shaped holding member 2131, an elastic member 2132, and an abutment block 2133 is fixed to the body 211 and has a recess O formed on the top surface, the L-shaped holding member 2131 is rotatable provided on the body 211 and has a rear end extending upwardly along a bar portion L to form a capacity space S which extends along the one of the L-shaped holding member 2131 in the direction Dp And is provided between the abutment block 2133 and the L-shaped holding member 2131 in the recess O. In this way, the L-shaped holding member 2131 is urged against the abutting direction Dp by the ramming shaft body 212a to expose the accommodating space S, and the bar hook portion L of the L-shaped holding member 2131 is moved by the ramming shaft body 212a in the abutting direction Dp Return to the original position, and the wire into the tolerance line S, so as to achieve the function of clamping wire.

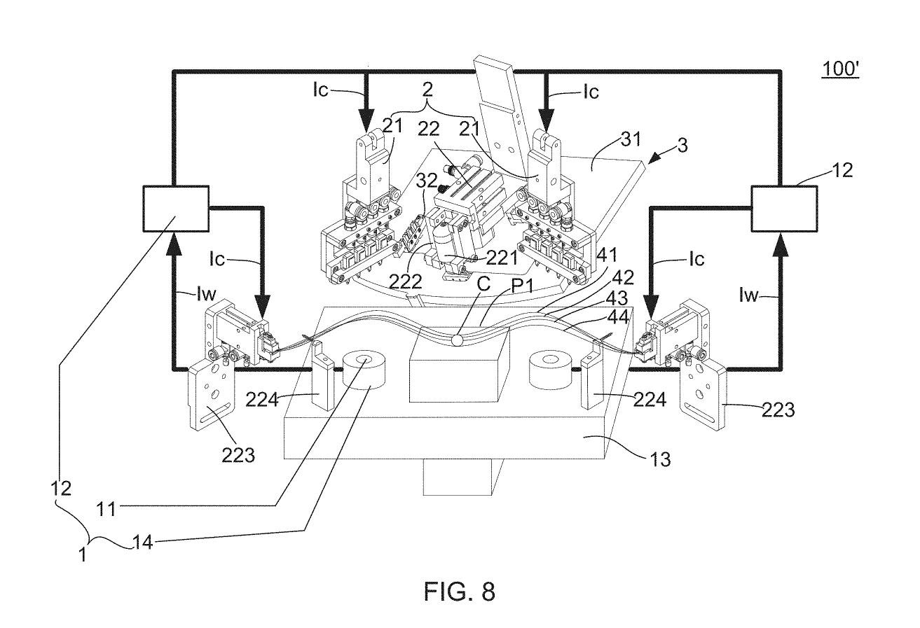

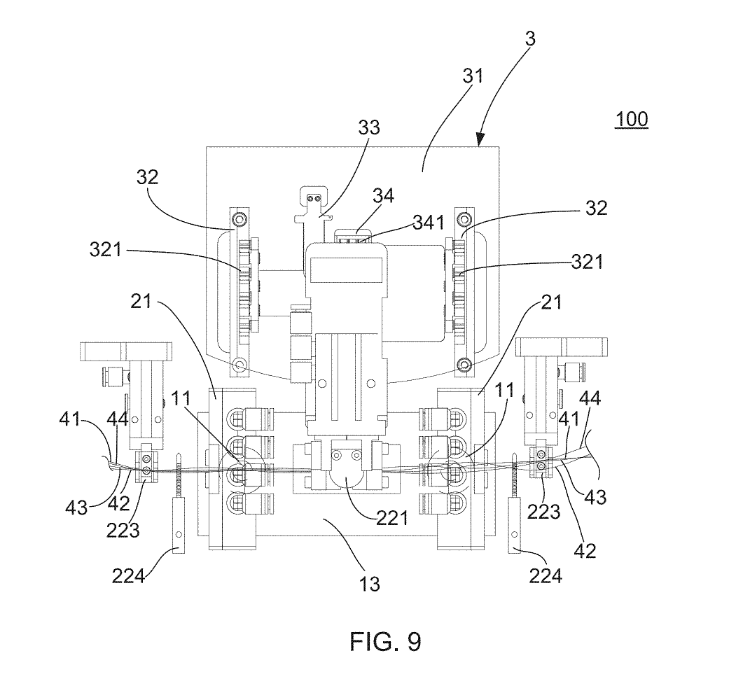

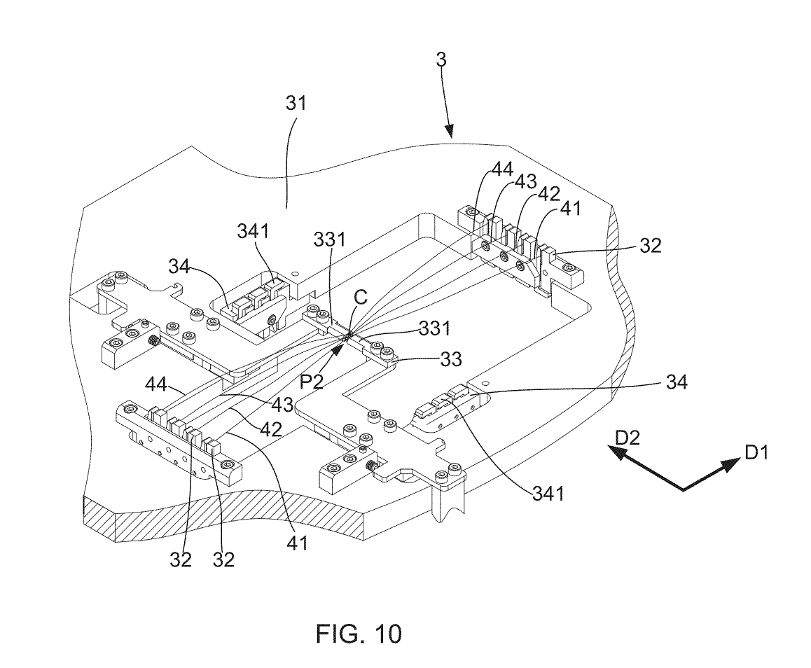

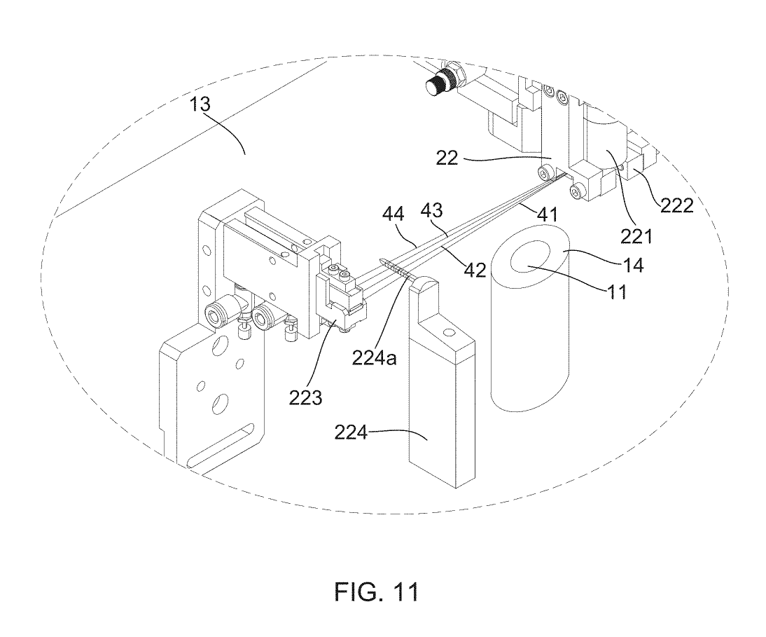

Please simultaneously refer to FIG. 8-FIG. 11, there are respectively shown a conceptual diagram of a wire-selecting device according to the second embodiment of the invention, the top plan view of a wire-selecting device according to the second embodiment of the invention, the stereo view of a pending iron core seat according to the second embodiment of the invention, and the conceptual diagram of a wires baffle device according to the second embodiment of the invention. Which is substantially the same as the wire-selecting device 100 of the first embodiment, except that the wire-selecting device 100′ further compresses a core fixing mechanism 22 which connects the visual discriminating system 1 including a magnet member 221 and a core clip 222 is provided on both sides of the magnet member 221, and the iron core fixing mechanism 22 fixes the iron core C at the wire-selecting position P1. Whereby the iron core C can be more stably located at the wire-selecting position P1. The magnetic member 221 is an electromagnet in this embodiment but is not limited thereto. The core fixing mechanism 22 may also be a mechanical gripping arm, a fixed shaft which may pass through the iron core C, or other mechanism and to fix the iron core C.

According to the technical means employed in the present invention, as shown in the wire-selecting device 100′ of the magnetic element of the second embodiment, the iron core fixing mechanism 22 further comprises two wire clips 223, which are displaceable provided on the core clip 222 Outer sides so that the wire clips 223 are provided on both sides of the iron core C. As shown in Fig. The two wire clips 223 hold the wires 41 to 44, respectively, and the two wire clips 223 are respectively held by a plurality of wires in a direction away from the iron core C to move the plurality of conductors 41-44 are pulled to a preset tension strength. Thereby, it is possible to make the conductive lines 41 to 44 to expand the apparent image pickup module 11 of the identification.

Referring to FIG. 8-FIG. 11 again, the wire-selecting module 2 further comprising a wires baffle device 224 having a plurality of guide grooves 224a, which used for limiting the plurality of metal wires 41-44 between the respective guide grooves 224a. It is to be noted that the centering mechanism 224 may also be used in conjunction with the cable clamp 223, which is first stretched by the cable clamp 223 and then against the wire 41 44 so that the time period is located between the respective guide grooves 224a, not only the wire can be easily recognized, but also the wire can be more easily clamped to the sub-clamps 21, thereby shortening the process time and improving the production efficiency.

Preferably, as shown in FIGS. 8 to 10, the pending iron core seat 3 to be treated may further comprises an iron core clip 33 disposed on the base 31, the iron core clip 33 having two gripping arms 331, gripping arms 331 is substantially matched to the icon core C, and the distance W at the lower edge between the clamping surfaces of the gripping arms 331 is smaller than the thickness Wc of the core. Therefore, the iron core C can be clamped by the iron core clip 33 and is not easily detached from the pending iron core seat 3.

Please continuously refer to FIG. 8-FIG. 10, the iron core positioning seat 3 further comprising a second sub-locating seat 34 having a plurality of thread holding portions 341, a plurality of second sub-positioning seat 34 to thread holding portion 341 is provided at one end and the opposite end of the seat 31 in a second direction D2, respectively, and the second direction D2 is substantially perpendicular to the first direction D1. Whereby the metal wires 41-44 can be fixed to the second sub-locating seat 34 after being stranded or otherwise processed so that the subsequent process is smooth. However, in other embodiments, the second direction D2 is substantially perpendicular to the first direction D1 and may also be set at an angle of non-90 degrees depending on the process requirements.

The above description is made on embodiments of the present invention. However, the embodiments are not intended to limit scope of the present invention, and all equivalent implementations or alterations within the spirit of the present invention still fall within the scope of the present invention.

What is claimed is:

1. A wire-selecting device, comprising:
a visual recognition system, comprising:
an image capture module, providing an image acquisition is determined by a plurality of wires to obtain a wire appearance information; and
a discrimination module, being connected to the image capture module; wherein the discrimination module providing a wire-selecting control information is determined by the image acquisition;
a wire-selecting module, comprising:
a plurality of sub-clamps, being connected to the visual recognition system;
wherein the sub-clamps are used to hold the wires at a wire-selecting position;
a pending iron core seat, comprising:
a base;
a first sub-positioning seat, being disposed on the base and having a plurality of thread holding portions; wherein the thread holding portions provided at one end and the opposite end of the base in a first direction so as to position the iron core in a waiting position;
wherein the wire-selecting module is respectively to perform a wire-selecting action so that the sub-clamps clamp the wires correspondingly to the metal wires and the metal wires from the wire-selecting position, which is displaced to the pending iron core seat, therefore the iron core is fixed to the waiting position for subsequent processing.

2. The wire-selecting device of claim 1, wherein the plurality of sub-clamps comprises: a body, a plurality of ramming shaft body and a plurality of clamping arms, which are arranged on the body and arranged in parallel and each of which is provided on the body and correspondingly disposed above the holding arm, the wire-selecting module receives the wire-selecting control information from the visual discriminating system so that the ramming shaft body is pressed up and down to hold or open the clamping arm.

3. The wire-selecting device of claim 2, wherein the plurality of clamping arms comprises: an L-shaped holding member, an elastic member, and an abutment block is fixed to the body and has a recess formed on the top surface which is displaceable provided on the top surface and a tail portion extending upwardly along the rear end to form a margin space which is provided in the groove along the direction of the abutting direction of the holding member and which is located in the abutment block between the holding pieces.

4. The wire-selecting device of claim 1, further comprising: a core fixing mechanism having a magnetic member and a core clip, the core fixing mechanism being disposed in the visual recognition system, and the iron core clamping mechanism is provided on both sides of the magnetic member, and the iron core fixing mechanism fixes the iron core at the distance.

5. The wire-selecting device of claim 4, wherein the core fixing mechanism comprises: Two wire clips, which are displaceable provided in the wire-selecting device, the wire clips being arranged on both sides of the core and holding the plurality of wires, and the two wire clips are held by the plurality of wires, respectively, in a direction away from the core to pull the plurality of wires to a predetermined tension strength.

6. The wire-selecting device of claim 1, wherein the wire-selecting module further comprising a wires baffle device having a plurality of guide grooves, which used for limiting the plurality of metal wires between the respective guide grooves.

7. The wire-selecting device of claim 1, wherein the pending iron core seat further comprising an iron core clip, being disposed on the base, wherein the core fixing clip having two gripping arms, the clamping surfaces of the gripping arms are substantially matched to the outer shape of the core and the distance between the lower edges of the gripping faces of the gripping arms is smaller than that of the core thickness.

8. The wire-selecting device of claim 1, wherein the pending iron core seat further comprising a second sub-positioning seat, being disposed in the base and having a plurality of thread holding portions; wherein the plurality of the second wire-selecting positioning seats is respectively provided at one end and the opposite end of the seat in a second direction, and the second direction is substantially perpendicular to the first direction.

9. The wire-selecting device of claim 1, wherein the image capturing module is arranged below the number of the sub-clamps corresponding to the number of the sub-clamps so that the image capturing direction of the image capturing module is substantially toward the plurality of wires, thereby performing the image acquisition operation on the plurality of metal wires.

10. The wire-selecting device of claim 1, wherein the visual discriminating system further comprising a light emitting element, which is enclosed in the image capturing module and the light emitting direction of the light emitting element is substantially oriented toward the plurality of wires.
